(19) United States
(12) Patent Application Publication
(10) Pub. No.: US 2022/0161592 A1
(43) Pub. Date: May 26, 2022

(54) Detectable Component for a Writing Implement

(71) Applicant: Sean Ronald Smith, Richmond, VA (US)

(72) Inventor: Sean Ronald Smith, Richmond, VA (US)

(73) Assignee: Sean Ronald Smith, Richmond, VA (US)

(21) Appl. No.: 17/439,696

(22) PCT Filed: Mar. 16, 2020
(86) PCT No.: PCT/GB2020/050665

§ 371 Date: Sep. 15, 2021

(30) Foreign Application Priority Data
Mar. 15, 2019 (GB) 1903576.5

(51) Int. Cl. B43K 7/00; B43K 7/02; B43K 7/12; B43K 24/08

(52) U.S. Cl. CPC B43K 7/005; B43K 7/02; B43K 15/00; B43K 24/08; B43K 7/12

(57) ABSTRACT

The invention relates to a writing implement such as a pen which includes a housing and an internal component in which there is provided a reservoir of ink. The internal component typically includes a portion such as a ballpoint which allows ink to be transferred from the reservoir to a surface to which the said portion is applied. The writing implement and/or internal component is rendered detectable by metal detection and/or X-ray detection apparatus when the internal component is within range of the same so that the internal component is detectable when separated, deliberately or inadvertently, from the remainder of the writing implement.

The invention to which this application relates is an item which is provided as a reservoir for ink for a writing implement such as a pen.

Typically, a pen comprises an outer housing with a cavity, inside which is located the reservoir, which is typically referred to as a refill and which has, at one end, a point, such as a ballpoint, via which the ink can be applied to a surface such as paper. From time to time, the liquid ink in the refill is used up and therefore the refill is removed from the housing and replaced with a new refill, full of ink.

The particular problem which is addressed in the current invention is the use of pens, and the refills for the same, in certain environments where it is necessary to be able to prevent, for health and safety reasons, the unexpected or unauthorised presence of items and, in particular, although not necessarily exclusively, these areas of manufacture include the manufacture of pharmaceuticals, foodstuffs and the like where, if an item is inadvertently or deliberately added during the production process, the item will remain in the pharmaceutical or foodstuff until the time of purchase and subsequent consumption which could cause the risk of injury or even death to the consumer, and/or the quality of the foodstuff or pharmaceutical is adversely affected.

It is known to provide means whereby the outer housing of the pen can be rendered detectable by metal detection apparatus either by producing the item wholly of a detectable metal or alternatively, to use a plastics material which includes therein, a sufficient number of metal detectable particles so as to render the housing, as a whole, metal detectable. However, this still means that certain components of the item, which are required to be separated from time to time, if they become separated inadvertently from the item, are not metal detectable and, as such, their presence in the foodstuff or pharmaceutical production process, is not identifiable. This means that, conventionally, pens used in these environments are provided as a one piece integral unit which means that when the ink has expired, the pen as a whole is discarded which is wasteful, and environmentally unacceptable.

An aim of the present invention is therefore to provide a writing implement of a form in which the same is rendered detectable by detection apparatus both as a complete item but also to ensure that separable components of the implement are detectable when separated from the implement and thereby ensuring that if they become separated from the implement, the same can still be detected and are not a potential hazard. A further aim is to provide a means of assessing the item to identify those components which may be separated from the item during use and which therefore need to be rendered detectable and a yet further aim is to provide a method of manufacture of those components so as to render the same metal detectable whilst maintaining the functionality of the same.

In a first aspect of the invention, there is provided a writing implement comprising a housing having, at at least one end thereof, an opening through which a portion of an internal component substantially located within the housing, passes so as to allow ink held in a reservoir in the internal component, to be supplied from the reservoir and applied to a surface via the said portion whilst the housing is held by a user and wherein the said internal component is provided with location means to allow the same to be located within the housing, said component extending along at least part of a longitudinal axis of the housing and the said reservoir is defined by walls of the said component and at least a portion of said walls include at least one material which is detectable by metal and/or X-ray detection apparatus, when the said writing implement and/or said internal component is within a detection range of said detection apparatus.

In one embodiment, the said detectable material which is used to form for at least a portion of the internal component external walls, is a plastics material with a quantity of metal and/or X-ray detectable material located and spread throughout the plastic material.

Typically, the size, number, material and/or spread of the detectable material of the internal component is selected so as to allow all said internal component to be detectable by metal detection apparatus. In addition or alternatively, the size, number and/or spread of detectable material in the internal component is selected as to allow the same to be detectable by X ray detection apparatus.

In one embodiment the quantity of the detectable material is sufficient to allow the internal component to be detectable by the detection apparatus when the internal component is separated from said housing.

In another embodiment the quantity of the detectable material is sufficient to allow the implement as a whole to be rendered detectable when the internal component is located within the housing.

In one embodiment the housing is formed of a material which is detectable.

In one embodiment, the material used to form the walls of the component, is a polymer material and the metal detectable particles, are magnetically attractive metal and X-ray detectable particles when provided are barium material.

In one embodiment, the internal component is provided in a form which is suitable to fit a particular housing with which the internal component is provided to be used.

Typically, the housing is provided of at least a two-part form such that the said parts can be selectively released from each other so as to allow the refill to be replaced when required.

In one embodiment the material used to form the said housing and/or component walls is an antimicrobial material.

In one embodiment the implement includes a retraction mechanism to allow the internal component to be moved between a retraction position within the housing and an in-use position in which the said component portion extends outwardly from the housing.

Typically the said components of the retraction mechanism are detectable by one of metal and/or X-ray detection apparatus.

In one embodiment the detection range is within 50 cm or greater.

In a further aspect of the invention there is provided an internal component for a writing implement, said internal component including a reservoir in which a quantity of ink is retained so to be supplied therefrom and applied to a surface via a portion of the internal component and wherein at least a portion of walls of the said internal component include at least one material which is detectable by metal and/or X-ray detection apparatus when the said writing implement and/or said internal component is within a detection range of said detection apparatus.

In one embodiment the said detectable material is metal particles and/or barium.

In one embodiment the said internal component is selectively locatable in a housing to form a writing implement.

In one embodiment said internal component is a refill for the writing implement.

In accordance with the invention the internal component can be formed so as to allow the same to be located in a housing and made available in a range of different dimensions and features so as to enable a purchaser to select the particular form of internal component which matches with their writing implement.

Specific embodiments of the invention are now described with reference to the accompanying drawings wherein;

FIG. 1 which shows a writing implement of a type with which the invention may be used.

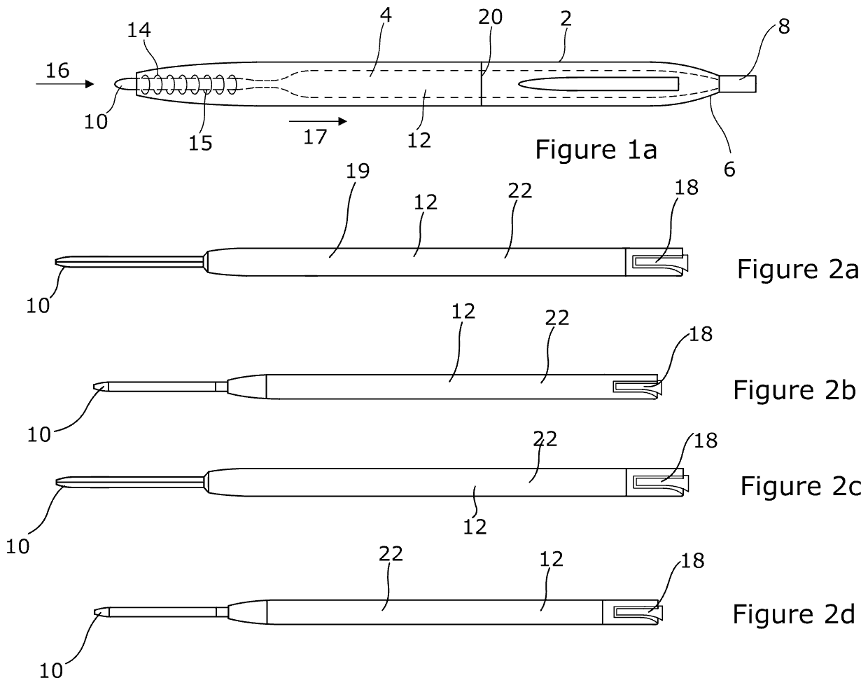

FIGS. 2a-d, illustrate side and end elevations of an internal component for use with the writing implement shown in FIG. 1; and

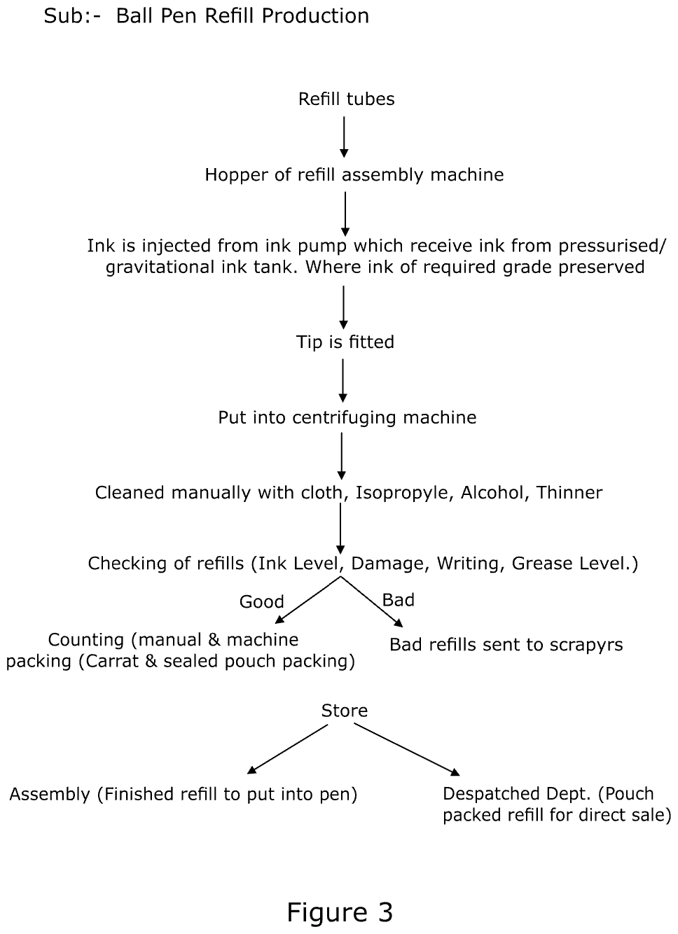

FIG. 3 illustrates flow chart of an embodiment of manufacture of the internal component of FIGS. 2a-d

Referring firstly to FIG. 1, there is illustrated a writing implement in the form of pen 2 which includes a housing 4 which forms the external surface of the pen and which is gripped when the pen is used. At one end 6 of the pen, there can be provided part of a retraction mechanism in the form of a button 8 which causes the movement of a ballpoint 10 of an internal component 12 at the opposing end 14 of the housing to be moved to an extended, in use position as shown in FIG. 1, or a retracted storage position in which the button 8 is pressed to release an engagement part and allows the biasing force of a spring 15 to act against the inner surface of the housing and move the internal component 12 in the direction of arrow 17 so that the portion 10 is moved with respect to the housing such that the portion 10 is moved inwardly of the housing as indicated by arrow 16. There are many different types of mechanisms which can be provided to achieve this and therefore the same are not described in detail here but in this case the internal component 12 has a formation 18 which engages with the button 8 to allow the movement of the internal component to be achieved.

The internal component 12 is shown in more detail in FIGS. 2a-d, and it will be clear that the internal component is a separate component of the pen and, while the same is located within the housing for normal use, when the internal component is empty of ink, the housing, which is typically formed of a two-part structure at the interface 20 with threaded engagement, can be released to allow the parts to be separated to allow the internal component 12 to be replaced with anew internal component with a reservoir 22 full of ink when the ink in the reservoir provided within the current internal component 12 has finished.

As a result of this ability to remove the refill internal component 12 from the housing, in order to allow the replacement of a refill with a full reservoir of ink, there is a significant risk that either the refill component 12 is dropped during the replacement procedure or, alternatively, the parts of the housing 4 become released from each other inadvertently which, in turn, causes the refill component to then be able to be removed freely from the housing and which may occur without the user of the pen being aware until the refill has disappeared. In industries where great efforts are made to avoid the possibility of foreign, contaminating objects entering, for example, a foodstuff, this is an unacceptable risk and, until now, has resulted in the use of single use, sealed, disposable writing implements which is wasteful and expensive.

In accordance with this invention, the internal component 12 with the ink reservoir is now formed of a material which is rendered detectable by one or both of X-ray detection and/or metal detection apparatus.

The detection apparatus can be used throughout production processes in order to protect consumers by detecting the presence of potential contaminants and preventing the contaminated product from ending up on retailers' shelves. The apparatus can be located at the end of a production line for a final product inspection and/or can be used in line to protect other machinery that is downstream in order to help prevent damage to processing equipment, which can cause downtime and costly repairs.

Commonly used metal detection apparatus performs detection, often using electromagnetic detection techniques, and typically includes the ability to detect materials which are ferrous metals which can be detected as they are both magnetic and conductive, and/or non-ferrous metals which are non-magnetic but are conductors and are therefore detectable and stainless steel contaminants. While the apparatus used can be provided indifferent formats, there are four types of metal detection apparatus that can typically be used and these can include search head apparatus for use for the inspection of fruits, vegetables, cereals, meats and bread; conveyor based systems; pipeline detection means for pumped products and/or vertical fall systems which are frequently used for powders, grains and granules.

X ray detection apparatus utilises a form of invisible electromagnetic energy with short wavelengths and high energies and the X-rays penetrate the food product and allows the imaging of the internal features of the food to detect physical defects or contaminants without damaging the food product. As the X-ray enters the food it loses some of its electromagnetic energy and the X-ray encounters the denser form of the internal component of the writing implement this reduces the X-ray energy further and as the X-ray leaves the food a sensor in the inspection equipment converts the X-ray into a greyscale image of the foodstuff interior with a denser contaminant appearing darker in the image. In one embodiment, and in accordance with the invention, the ability to detect the internal component, and hence make the same appear darker in the image, is enhanced by the provision of a specific detectable material such as barium.

In accordance with the invention, at least a portion, but most typically all, of the walls of the body 19 of the internal component which form the reservoir is formed of plastics material which includes a quantity and/or number of particles of metal and/or barium, which may be added in a liquid form, which is sufficient so as to render the refill component, and fragments thereof which may become detached in use, metal and/or X ray detectable, so the risk of hazard and injury caused by the presence of the refill component in the foodstuff is avoided.

The internal component typically comprises the tip, such as a ballpoint portion 10 at one end which is typically formed of a metal and is therefore metal detectable and, the metal portion is located with the reservoir 22 formed with walls of a plastics material including the detectable material and the reservoir extends towards the opposing end 18.

In accordance with the invention, the plastics housing is formed to include a metal and/or X-ray detectable material which, in one embodiment involves the inclusion of metal particles and/or barium liquid when the plastics is in a liquid form and the detectable material is dispersed throughout the plastics material which is then moulded into the required form and hardens to form the walls of the reservoir of the internal component 12.

FIG. 3 illustrates one particular method of manufacture of the refill component in accordance with the invention. Typically the internal component reservoir 22 is formed as an elongate tube and cut to the required length to allow the same to be received internally of the housing. The tubes are then moved successively to a filling station, in one embodiment, via a conveyor drum and each of the tubes is filled with a quantity of ink, typically by a pumping operation and which is held in the reservoir 22 with the tip portion 10 inserted into the end of the reservoir 22.

The filled refill components are then placed into a centrifuge machine to remove any trapped air from the reservoir and if they pass the required quality control checks are placed into the housing to form the writing implement.

In one embodiment the metal detectable and/or X-ray detectable material is mixed with the plastics material when the same is in a liquid form and is sufficiently mixed to produce a relatively homogenous mix. The quantity of the added detectable material preferably represents between 3% and 6% by volume of the plastics and material mix.

In one embodiment if the detectable material is added in a powder form, the particle size of the majority of the powder is preferably below 200 microns and would usually be above 1 micron. More preferably the particle size of the majority of the powder is in the range 50 to 200 microns and most preferably is in the range 50 to 100 microns. In addition to the metal detectable material being added to the walls of the reservoir of the internal component or refill it is possible that the ink may also include a material which renders the same detectable by X ray or metal detection apparatus when the component is within the detection range of the apparatus.

The current invention therefore provides that the internal component of the writing implement is rendered detectable by metal detection and/or X-ray detection apparatus when the internal component is within range of the same so that the internal component is detectable when separated, deliberately or inadvertently, from the remainder of the writing implement.

In one embodiment, the writing implement as a whole is rendered detectable by the provision of the detectable materials insufficient quantity in the internal component but more typically the external housing is formed of a detectable material as well as the internal component in accordance with the invention so that the parts are detectable separately.

1. A writing implement comprising a housing having, at least one end thereof, an opening through which a portion of an internal component substantially located within the housing, passes so as to allow ink held in a reservoir in the internal component, to be supplied from the reservoir and applied to a surface via the said portion whilst the housing is held by a user and wherein the said internal component is provided with location means to allow the same to be located within the housing, said component extending along at least part of a longitudinal axis of the housing and the said reservoir is defined by walls of the said component and at least a portion of said walls include at least one material which is detectable by metal and/or X-ray detection apparatus, when the said writing implement and/or said internal component is within a detection range of said detection apparatus.

2. An implement according to claim 1 wherein the detectable material which is used for at least a portion of the component external walls is a plastics material with a quantity of metal and/or X-ray detectable material located therein.

3. An implement according to claim 2 wherein the said detectable material is spread throughout the plastics material in a substantially uniform dispersal.

4. An implement according to claim 1 wherein the said detectable material is provided in a sufficient quantity to render the said writing implement detectable by the detection apparatus when the said internal component is located in the housing.

5. An implement according to claim 1 wherein the said detectable material is a metal or a metal alloy which is of a type which can be detected by metal detection apparatus.

6. An implement according to claim 1 wherein the said detectable material is a barium material.

7. An implement according to claim 1 wherein the said portion of the component includes a means to allow the controlled flow of ink from the reservoir onto a surface when the said portion is contacted onto said surface.

8. An implement according to claim 7 wherein at the end of the implement opposing said portion there is provided a cap locatable with a retraction mechanism to allow said internal component to linearly movable with respect to the housing between an extended, in use position and a retracted storage position.

9. An implement according to claim 8 wherein the retraction mechanism is biased towards the retracted position and includes a locating means to retain the internal component in an in-use position when that is selected.

10. An implement according to claim 1 wherein the housing is provided in a two-part form with engagement means which, when released, allow the said parts to be separated and allow the internal implement to be replaced when required.

11. An implement according to claim 1 wherein the material used to form the said housing and/or the component walls includes an antimicrobial material.

12. An implement according to claim 1 wherein the metal detectable and/or X-ray detectable material is mixed with plastics material when the same is in a liquid form and then the mix is used to form the walls of the said reservoir of the internal component.

13. Apparatus according to claim 1 wherein the detection range is within 50 cm or greater.

14. An internal component for a writing implement, said internal component including a reservoir in which a quantity of ink is retained so to be supplied therefrom and applied to a surface via a portion of the internal component and wherein at least a portion of the walls of the said internal component include at least one material which is detectable by metal and/or X-ray detection apparatus when the said writing implement and/or said internal component is within a detection range of said detection apparatus.

15. An internal component according to claim 14 wherein the said detectable material is metal particles and/or barium.

16. An internal component according to claim 14 wherein the said internal component is selectively locatable in a housing to form a writing implement.

17. An internal component according to claim 14 wherein said internal component is a refill for the writing implement.
